(19) United States
(12) Patent Application Publication
(10) Pub. No.: US 2019/0313112 A1
(43) Pub. Date: Oct. 10, 2019

(54) METHOD FOR DECODING VIDEO SIGNAL AND APPARATUS THEREFOR

(71) Applicant: INDUSTRY ACADEMY COOPERATION FOUNDATION OF SEJONG UNIVERSITY, Seoul (KR)

(72) Inventors: Jong-Ki Han, Seoul (KR); Jae-Yung Lee, Gyeonggi-do (KR)

(21) Appl. No.: 16/339,483

(22) PCT Filed: Sep. 27, 2017
(86) PCT No.: PCT/KR2017/010699

§ 371 Date: Jun. 27, 2019

(30) Foreign Application Priority Data
Oct. 6, 2016 (KR) 10-2016-0129138
Sep. 22, 2017 (KR) 10-2017-0122651

(51) Int. Cl. H04N 19/44; H04N 19/137; H04N 19/105; H04N 19/30; H04N 19/176

(52) U.S. Cl. CPC H04N 19/44; H04N 19/137; H04N 19/176; H04N 19/30; H04N 19/105

(57) ABSTRACT

The present invention relates to a method for decoding a video signal comprising a step for obtaining a reference picture list indicating at least more than one reference picture information of a current block; a step for obtaining a motion vector of a temporally collocated block of the current block and a reference picture information of the temporally collocated block; a step for confirming whether or not the reference picture information of the temporally collocated block is included in the reference picture list of the current block; and a step for setting a target reference picture for scaling a motion vector of the temporally collocated block according to whether the reference picture information of the temporally collocated block is included or not.

### TECHNICAL FIELD

The present invention relates to a method and an apparatus for decoding a video signal, and more particularly, to a method and an apparatus for setting a target reference picture for obtaining a motion vector.

### BACKGROUND ART

Recently, the demand for high resolution and high-quality pictures such as High Definition (HD) picture and Ultra High Definition (UHD) picture is remarkably increasing in various applications. Since the amount of data increases as compared with the conventional picture data as the picture data becomes high resolution and high quality, when the picture data is transmitted using a medium such as a wired/wireless broadband line or stored using an existing storage medium, the cost and the storage cost accordingly increase. High-efficiency picture compression techniques may be utilized to solve such problems as picture data is becoming high-resolution and high-quality step by step.

In a video coding system, a space and time redundancy are exploited using spatial and temporal prediction to reduce the information to be transmitted. Spatial and temporal prediction uses pixels decoded from the same picture and reference picture, respectively, in order to form a prediction for the coded current pixel. In a conventional coding system, since the auxiliary information associated with spatial and temporal prediction is transmitted, a large amount of bit rate may be used for transmission of a motion vector for temporal prediction even in a coding system using a low bit rate.

Recently, in the video coding field, a technique called Motion Vector Prediction (MVP) has been used to further reduce the bit rate associated with a motion vector in order to solve this problem. The MVP scheme exploits statistical redundancy between spatially and temporally collocated motion vectors.

A motion vector of a spatially or/and temporally collocated block is used to generate a motion vector or prediction motion vector of a current block. Since the temporally collocated block is located in a picture temporally different from the current picture, the reference picture list used for coding the current block and the reference picture list used for coding the temporally collocated block may be different. However, even though the reference picture lists are different from each other, the coding efficiency may be reduced by using the reference picture list of the current block for scaling the motion vector of the temporally collocated block.

### DISCLOSURE OF THE INVENTION

### Technical Problem

An object of the present invention is to provide a method and an apparatus for decoding a video signal that improves coding efficiency in inter prediction by using reference pictures of temporally collocated blocks

Another object of the present invention is to provide a method and an apparatus for decoding a video signal that improves coding efficiency in inter prediction by obtaining residual merge candidates using previously acquired merge candidates.

Further, another object of the present invention is to provide a decoding method and an apparatus for a video signal that may improve coding efficiency by using a reference picture of the same picture type as a target reference picture.

### Technical Solution

In order to accomplish the above-described objects, there is provided a method for decoding a video signal according to one embodiment of the present invention, the method comprising: a step for obtaining a reference picture list indicating at least more than one reference picture information of a current block; a step for obtaining a motion vector of a temporally collocated block of the current block and a reference picture information of the temporally collocated block; a step for confirming whether or not the reference picture information of the temporally collocated block is included in the reference picture list of the current block; and a step for setting a target reference picture for scaling a motion vector of the temporally collocated block according to whether the reference picture information of the temporally collocated block is included or not.

The step for setting the target reference picture may set the reference picture information as the target reference picture if the reference picture information of the temporally collocated block is included in the reference picture list.

In one embodiment, the step for setting the target reference picture may set a reference picture having the smallest index among the reference picture list as the target reference picture if the reference picture information of the temporally collocated block is not included in the reference picture list.

Further, the present invention may include a step for dividing a current block into at least two or more sub-blocks; a step for obtaining a motion vector of a spatially collocated block of the sub-block; a step for scaling a motion vector of the temporally collocated block using the target reference picture; and a step for generating a motion vector of the sub-block using the motion vector of the spatially collocated block and the motion vector of the scaled temporally collocated block.

In one embodiment, the step for setting the target reference picture may set the reference picture information as the target reference picture when the reference picture information of the temporally collocated block is included in the reference picture list. The step for setting the target reference picture may set the reference picture information having a smaller index among the reference picture information of the spatially collocated block included in the reference picture list, as the target reference picture, when the reference picture information of the temporally collocated block is not included in the reference picture list.

In order to accomplish the other objects, a method for decoding a video signal includes a method for obtaining a merge candidate of a merge mode according to the present invention, the method for obtaining a merge candidate comprising; a step for obtaining a maximum number information of merge indicating a maximum number of merge candidates in the merge mode; a step for obtaining a merge candidate of the current block using at least more than one motion vector selected from a motion vector of a temporally collocated block of a current block and a motion vector of a spatially collocated block; a step for comparing the number of obtained merge candidates with the maximum number information of merge; and a step for obtaining a residual merge candidate by scaling the obtained merge candidate if the number of obtained merge candidates is smaller than the maximum number information of merge.

The step for obtaining the residual merge candidate scales the obtained merge candidate using the target reference picture, and the target reference picture is different from the reference picture of the obtained merge candidate, and may be a reference picture having the smallest index among the reference picture list.

In order to accomplish another object described as above, there is provided a method for decoding a video signal according to another embodiment of the present invention, the method comprising: a step for obtaining a reference picture list indicating at least more than one reference picture information of a current block; a step for obtaining a motion vector of a temporally collocated block of the current block and a reference picture information of the temporally collocated block; a step for confirming whether a type of a reference picture of a temporally collocated block of the current block, and a type of a reference picture having a small index of the reference picture list are identical or not; a step for setting a reference picture of the same type as the temporally collocated reference picture as a target reference picture if the types of the reference pictures are same; and a step for determining whether the type of the reference picture in the reference picture list, and the type of the reference picture of the temporally collocated block are same or not by incrementing the index of the reference picture list by one if the types of the reference picture are different from each other.

In one embodiment, the reference picture of the same type may be a reference picture having the smallest index among the reference pictures of the same type as the temporally collocated reference picture. The method according to the present invention further may include a step for determining whether the type of the reference picture of the temporally collocated block is a short-term reference picture or not, if the type of the reference picture of the temporally collocated block is same as the type of the reference picture having the small index of the reference picture list; a step for setting a reference picture of the same type in the reference picture list as the target reference picture for a motion vector of the temporally collocated block if the type of the reference picture of the temporally collocated block is a short-term reference picture; a step for scaling a motion vector of the temporally collocated block using the same type of reference picture of the same type, and using the scaled motion vector as a merge candidate; and a step for using the motion vector of the temporally collocated block as a merge candidate of the current block without scaling the motion vector of the temporally collocated block if the type of the reference picture of the temporally collocated block is a long-term reference picture.

Further, it is determined whether the type of the reference picture is same as the type of all the reference pictures in the reference picture list or not, and a step for allocating a predetermined value as a motion vector of the current block when the type of the reference picture is different from the type of all reference pictures in the reference picture list may be further included.

In order to accomplish the another object, there is provided an method for decoding a video signal according to one embodiment of the present invention, and the method may comprise: a picture information obtaining unit for obtaining a reference picture list indicating at least more than one reference picture information of a current block, a motion vector of a temporally collocated block of the current block, and a reference picture information of the temporally collocated block; a reference picture information discrimination unit for confirming whether a reference picture information of the temporally collocated block is included in the reference picture list of the current block; and a target reference picture setting unit configured to set a target reference picture for scaling a motion vector of the temporally collocated block according to whether the reference picture information of the temporally collocated block is included or not.

### Advantageous Effects

According to an embodiment of the present invention, there is provided a decoding method and a decoding apparatus of a video signal for improving coding efficiency in inter prediction by using a reference picture of the temporally collocated block as a target reference picture for scaling a motion vector of a temporally collocated block. Even when a spatially collocated block is used as well as a temporally collocated block to generate a predictive motion vector of a current block, if a reference picture of the picture including the temporally collocated block is included in the reference picture list of the current block, the reference picture of the picture including the temporally collocated block is used as the target reference picture for scaling the motion vector, thereby improving the coding efficiency in the inter prediction.

Further, according to another embodiment of the present invention, a video signal decoding method and apparatus thereof capable of improving coding efficiency by using a motion vector obtained by scaling a motion vector of a temporally collocated block as a residual merge candidate in a merge mode may be provided.

Further, according to another embodiment of the present invention, a reference picture in a reference picture list of a current block having the same picture type as a reference picture of a temporally collocated block may be used as a target reference picture and accordingly, the prediction motion vector of the current block may be effectively coded.

### BRIEF DESCRIPTION OF THE DRAWINGS

FIG. 1 is a block diagram schematically illustrating a video encoding apparatus according to an embodiment of the present invention.

FIG. 2 is a block diagram schematically illustrating a video decoding apparatus according to an embodiment of the present invention.

FIG. 3 is a block diagram illustrating temporally and spatially neighbor blocks of a current block according to a general method.

FIG. 4 is a flowchart illustrating a method for decoding a video signal for setting a target reference picture according to an embodiment of the present invention.

FIG. 5 is a flowchart illustrating a method for setting a target reference picture according to an embodiment of the present invention.

FIG. 6 is a diagram illustrates a method for setting a target reference picture according to an embodiment of the present invention.

FIG. 7 and FIG. 8 are diagrams illustrating the temporally and spatially neighbor blocks of the current sub-block according to a general method.

FIG. 9 is a diagram illustrating a method for obtaining a motion vector using a target reference picture according to another embodiment of the present invention.

FIG. 10A and FIG. 10B are the diagrams illustrating a method for obtaining a residual merge candidate according to another embodiment of the present invention

FIG. 11 is a flowchart illustrating a method for setting a target reference picture according to another embodiment of the present invention.

FIG. 12 is a diagram illustrating a method for setting a target reference picture according to another embodiment of the present invention.

### MODE FOR CARRYING OUT THE INVENTION

Hereinafter, the preferred embodiments of the present invention will be described in detail with reference to the accompanying drawings.

The embodiments of the present invention are provided in order to more fully explain the present invention to those having a common knowledge in the related art, and the following embodiments may be modified into various other forms. The scope of the present invention is not limited to the following embodiments. Rather, these embodiments are provided so that this disclosure will be more faithful and complete, and the concept of the invention may be completely conveyed to those having a common knowledge in the related art.

Further, the thickness and the size of each unit are exaggerated for convenience and clarity of description in the drawings, and the same reference numerals denote the same elements in the drawings. As used herein, the expression “and/or” includes any one of the listed items and all combinations of more than one of the listed items.

The terminology used herein is employed only for the purpose of describing particular embodiments and is not intended to be limiting of the invention. As used herein, the singular forms may include plural forms unless the context clearly dictates otherwise. Also, it is to be understood that the term, “comprise” and/or “comprising” used herein should be interpreted as specifying the presence of stated shapes, numbers, steps, operations, members, elements, and/or a group selected from the above listed ones, and the term does not preclude the presence or addition of one or more other features, integers, operations, members, elements, and/or the groups thereof.

Although the terms such as the first, the second, and the like are used herein to describe various elements, units, members, components, regions and/or sections, it is apparent that these elements, units, members, components, regions and/or sections should not be limited by these terms. Therefore, the first element, the first unit, the first member, the first component, the first region, or the first section described below may refer to the second element, the second unit, the second member, the second component, the second region, or the second section, respectively, without departing from the teachings of the present invention. Furthermore, the expression, “and/or” includes any combination of the plurality of related items which are described in the specification or any one of the pluralities of related items which are described in the specification.

When an element is referred to as being “coupled” or “connected” to other element, it is to be understood that the above terms include a case wherein the element is directly coupled or connected to the other element, and the case wherein there is another element between the above-described element and the other element. However, when an element is referred to as being “directly coupled” or “directly connected” to other element, it should be understood that there are no other elements between the element and the other element, and the above element and the other element are directly coupled or connected.

Hereinafter, the embodiments of the present invention will be described with reference to the drawings schematically showing ideal embodiments of the present invention. In the drawings, for example, the size and the shape of the members may be exaggerated for convenience and clarity of explanation, and in actual implementation, variations of the illustrated shape may be expected. Accordingly, the embodiments of the present invention should not be construed as limited to any particular shape of the regions shown herein.

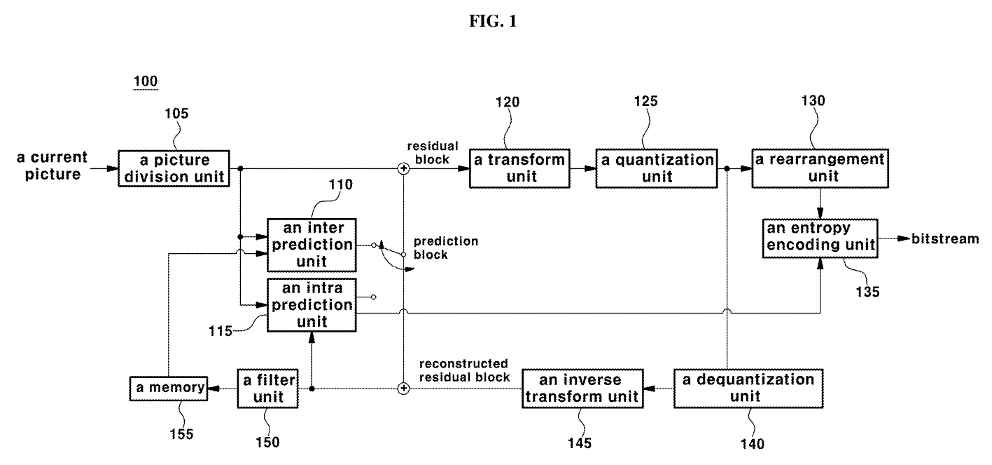

FIG. 1 is a block diagram schematically showing an encoding apparatus according to an embodiment of the present invention.

Referring to FIG. 1, an encoding apparatus 100 includes a picture division unit 105, an inter prediction unit 110, an intra prediction unit 115, a transform unit 120, a quantization unit 125, a re-arrangement unit 130, an entropy encoding unit 135, an dequantization unit 140, an inverse transform unit 145, a filter unit 150, and a memory 155.

Each component shown in FIG. 1 is shown independently in order to represent different characteristic functions in the encoding apparatus, and does not mean that each component is composed of a separate hardware or one software configuring unit. That is, each component is listed as a separate component and is included in the present invention for convenience of explanation. At least two components of each component are combined to form one component, or one component is divided into a plurality of components for performing concerned functions. It is to be understood that the embodiments in which each of these components is integrated or the embodiments in which the components are divided may be included in the scope of the present invention without departing from the essential aspect of the present invention.

The picture division unit 105 may divide an input picture into slices or tiles, and the tiles may include a plurality of slices. The slice or tile may all be a set of a plurality of coding tree blocks. Since the tile may independently perform coding processing on the current picture, it may be mentioned that it is an important division for parallel processing of pictures.

In addition, the picture division unit 105 may divide the input picture into at least one processing unit. Here, the processing unit is not a unit incompatible with a slice or tile, and the slice or tile may be a parent concept including the processing units. The processing unit may be a prediction unit (hereinafter, it is described as “PU”), a transform unit (hereinafter, it is described as “TU”), or a coding unit (hereinafter, it is described as “CU”). However, for the sake of convenience of explanation, the prediction block may be expressed as a prediction unit, the transform block may be expressed as a transform unit, and the encoding block or decoding block may be expressed as an encoding unit or a decoding unit, respectively.

In one embodiment, the picture division unit 105 divides one picture into a combination of a plurality of encoding blocks, a prediction block, and a transform block, and a picture may be encoded by selecting a combination of an encoding block, a prediction block, and a transform block based on a predetermined criterion (e.g., a cost function).

For example, one picture may be divided into a plurality of coding blocks. In one embodiment, a picture may be divided into coding blocks using a recursive tree structure such as a quad tree structure or a binary tree structure, and a coding block which is divided into other coding blocks by designating one picture or the largest coding unit as a root may be divided so as to have the child nodes as many as the number of the divided coding blocks. Through this process, the coding block which may not be further divided may become a leaf node.

The prediction block may also be divided into at least one square or non-square shape of the same size in one coding block, and any one of the divided prediction blocks in one coding block may be divided so as to have a shape and a size which are different from a shape and a size of another prediction block. In one embodiment, the coding block and the prediction block may be the same. That is, a prediction step may be performed based on the divided coding blocks without distinguishing between the coding blocks and the prediction blocks.

The prediction unit may include an inter prediction unit 110 for performing inter prediction and an intra prediction unit 115 for performing intra-prediction. In order to enhance the coding efficiency, instead of coding a picture signal as it is, a picture is predicted using a specific region in the already encoded and decoded picture, and the residual value between the original picture and the predicted picture is encoded. In addition, the prediction mode information, motion vector information, and the like used for prediction may be encoded by the entropy encoding unit 135 and transmitted to the decoding unit together with the residual value. When a particular encoding mode is used, the original block may encoded as it is without generating a prediction block through the prediction units 110 and 115, and may be transmitted to the decoding unit.

In one embodiment, the prediction units 110 and 115 determine whether to perform inter prediction or intra prediction for a prediction block, and may also determine specific information such as the inter prediction mode, the motion vector, and the reference picture, which are obtained according to each method of the prediction methods. In this case, the processing unit in which the prediction is performed, the prediction method thereof, and the detail processing unit may be different from each other. For example, even if the prediction mode and the prediction method are determined according to the prediction block, a prediction step may be performed according to the transform block.

The prediction units 110 and 115 may generate prediction blocks composed of the predicted samples by performing a prediction process for the processing units of the pictures divided in the picture division unit 105. The picture processing unit of the prediction units 110 and 115 may be a coding block unit, a transform block unit, or a prediction block unit.

The inter prediction unit 110 may predict a prediction block based on information of at least any one of a previous picture and a following picture of the current picture, and in some cases, a prediction block may be predicted based on the information of the partial area in which the coding in the current picture is completed. The inter prediction unit 110 may include a reference picture interpolation unit, a motion prediction unit, and a motion compensation unit.

Unlike the inter prediction, the intra prediction unit 115 may generate a prediction block based on reference pixel information in the vicinity of the current block, which is pixel information in the current picture. In the case where the collocated blocks of the prediction block are blocks in which the inter prediction is performed, that is, when the reference pixels are pixels performing inter prediction, it is also possible to replace the reference pixels included in a block for which an inter prediction is performed, with the reference pixel information of the block for which an intra prediction is performed.

A residual value (a residual block or a residual signal) between the prediction block and the original block generated by the intra prediction unit 115 may be input to the transform unit 120. In addition, the prediction mode information, the interpolation filter information, and the like used for prediction may be encoded by the entropy encoding unit 135 together with the residual value and may be transmitted to the decoder.

The transform unit 120 may transform an original block and a residual block including a residual value information of the prediction unit generated by using the prediction unit 110 and 115 by a transform unit by using the transform method such as a discrete cosine transform (DCT) and a discrete sine transform (DST), and a KLT (Karhunen Loeve transform). The quantization unit 125 may quantize the residual values transformed by the transform unit 120 to generate a quantization coefficient. In one embodiment, the transformed residual values may be a transformed value in a frequency domain.

The re-arrangement unit 130 may rearrange the quantization coefficients provided from the quantization unit 125. The re-arrangement unit 130 may improve the coding efficiency in the entropy encoding unit 135 by rearranging the quantization coefficients. The re-arrangement unit 130 may rearrange the quantization coefficients of the two-dimensional block form into a one-dimensional vector type through a coefficient scanning method. The entropy encoding unit 135 may perform entropy encoding on the quantization coefficients rearranged by the re-arrangement unit 130. For entropy encoding, various encoding methods such as Exponential Golomb, Context-Adaptive Variable Length Coding (CAVLC), and Content-Adaptive Binary Arithmetic Coding (CABAC) may be used.

The dequantization unit 140 dequantizes the quantized values in the quantization unit 125 and the inverse transformation unit 145 inversely transforms the dequantized values in the dequantization unit 140. The residual values generated by the dequantization unit 140 and the inverse transform unit 145 may be combined with prediction blocks predicted by the prediction units 110 and 115 to generate a reconstructed block. The picture composed of the prediction blocks may be a motion compensated picture or an MC picture (Motion Compensated Picture).

The reconstructed block may be input to the filter unit 150. The filter unit 150 may include a deblocking filter unit, a sample adaptive the sample adaptive offset (SAO) unit, and an adaptive loop filter (ALF) unit. In summary, a deblocking filter may be applied in a deblocking filter unit to reduce or eliminate blocking artifacts of the reconstructed block, and then may be input to a sample adaptive the sample adaptive offset unit to correct the sample adaptive offset unit. The picture output from the sample adaptive the sample adaptive offset unit is input to the adaptive loop filter unit, passes through an ALF (Adaptive Loop Filter) filter, and the picture passed through the filter may be transmitted to the memory 155.

The memory 155 may store a reconstructed block or a reconstructed picture calculated through the filter unit 150. The reconstructed block or picture stored in the memory 155 may be provided to the inter prediction unit 110 or the intra prediction unit 115 for performing inter prediction. The pixel values of the reconstruction blocks used in the intra prediction unit 115 may be data to which the deblocking filter unit, the sample adaptive the sample adaptive offset unit, and the adaptive loop filter unit are not applied.

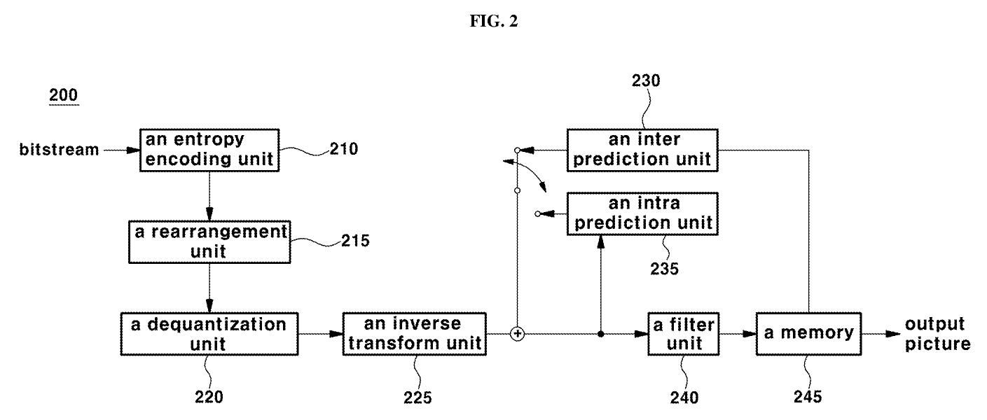

FIG. 2 is a block diagram schematically illustrating a decoding apparatus according to an embodiment of the present invention. Referring to FIG. 2, a decoding apparatus 200 includes an entropy decoding unit 210, a re-arrangement unit 215, a dequantization unit 220, an inverse transform unit 225, an inter prediction unit 230, an intra prediction unit 235, a filter unit 240, and a memory 155.

When a picture bit stream is input from the encoding apparatus, the input bit stream may be decoded according to an inverse process of a process during which a piece of picture information is processed in the encoding apparatus. For example, when variable length coding (hereinafter, it is described as “VLC”) such as CAVLC, is used to perform entropy coding in an encoding apparatus, the entropy decoding unit 210 may also perform entropy decoding by implementing a VLC table identical to the VLC table used in the encoding apparatus. Further, when CABAC is used to perform entropy encoding in the encoding apparatus, the entropy decoding unit 210 may perform entropy decoding using CABAC in correspondence thereto.

The entropy decoding unit 210 provides the information for generating a prediction block among the decoded information to the inter prediction unit 230 and the intra prediction unit 235. The residual values for which an entropy-decoding process is applied in the entropy decoding unit 210 may be input to the re-arrangement unit 215.

The re-arrangement unit 215 may rearrange the entropy-decoded bit stream of the entropy decoding unit 210 based on the rearrangement method via a picture encoder. The re-arrangement unit 215 may perform rearrangement step by receiving information related to the coefficient scanning performed by the encoding apparatus, and performing a reverse scanning based on the scanning order performed by the encoding apparatus.

The dequantization unit 220 may perform a dequantization process based on the quantization parameters provided from the encoding apparatus and the coefficient values of the re-arranged blocks. The inverse transform unit 225 may perform an inverse DCT process, an inverse DST process, or an inverse KLT process on the DCT, DST, or KLT performed by the transform unit of the encoding apparatus on the quantization result performed by the picture encoding apparatus. The inverse transform may be performed based on the transmission unit determined by the encoding apparatus or the division unit of the picture. The transform unit of the encoding apparatus may selectively perform DCT, DST, or KLT according to a prediction method, and a piece of information such as a size and a prediction direction of the current block, and the inverse transform unit 225 of the decoding apparatus may determine the inverse transform method based on the transformed information processed by the transforming unit of the encoding apparatus to perform an inverse transform process.

The prediction units 230 and 235 may generate a prediction block based on a piece of information related to generation of a prediction block provided by the entropy decoding unit 210, and the previously decoded block and/or picture information provided in the memory 245. The reconstructed block may be generated using the prediction block generated by the prediction units 230 and 235 and the residual block provided by the inverse transform unit 225. The concrete prediction method performed by the prediction units 230 and 235 may be the same as the prediction method performed by the prediction units 110 and 115 of the encoding apparatus.

The prediction units 230 and 235 may include a prediction unit determination unit (not shown), an inter prediction unit 230, and an intra prediction unit 235. The prediction unit determination unit may receive various information such as prediction unit information input from the entropy decoding unit 210, a prediction mode information of the intra prediction method, a piece of information related to motion prediction of the inter prediction method, identify a prediction block in the current coding block, and determine whether the prediction block performs inter prediction or intra prediction.

The inter prediction unit 230 may use information necessary for inter prediction of the current prediction block provided by the encoding apparatus, and may perform an inter prediction for the current prediction block based on a piece of information included in at least any one of a previous picture or a following image in which he current prediction block is included. The motion information including the motion vector and the reference picture index necessary for the inter prediction of the current block may check a skip flag and a merge flag received from the encoding apparatus, and may be accordingly derived in response to the confirming result.

The intra prediction unit 235 may generate a prediction block based on the pixel information in the current picture. If the prediction unit is a prediction unit that performs an intra prediction, the intra prediction may be performed based on the intra prediction mode information of the prediction unit provided by the picture encoding apparatus. In the case where the collocated blocks of the prediction unit are the blocks on which the inter prediction is performed, that is, when the reference pixels are the pixels performing the inter prediction, it is also possible to replace the reference pixels included in the block for which the inter prediction is performed with the reference pixel information of the block for which intra prediction is performed.

In addition, the intra prediction unit 235 may use the most probable mode (MPM) of intra prediction obtained from the collocated blocks to encode the intra prediction mode. In one embodiment, the most probable intra prediction mode may utilize the intra prediction mode of the spatially collocated block of the current block.

The intra prediction unit 235 may include an AIS (Adaptive Intra Smoothing) filter unit, a reference pixel interpolation unit, and a DC filter unit. The AIS filter unit performs filtering on the reference pixels of the current block and may determine whether to apply the filter according to the prediction mode of the current prediction unit. The AIS filtering may be performed on the reference pixels of the current block using the prediction mode of the prediction unit provided in the picture encoding apparatus, and the AIS filtering information. If the prediction mode of the current block is a mode in which AIS filtering is not performed, the AIS filter unit may not be applied to the current block.

The reference pixel interpolation unit may interpolate a reference pixel to generate a reference pixel as a pixel unit less than an integer value when the prediction mode of the prediction unit is a prediction unit which performs an intra-frame prediction based on a sample value obtained by interpolating a reference pixel. If the prediction mode of the current prediction unit is a prediction mode which generates a prediction block without interpolating the reference pixel, the DC filter unit may generate a prediction block through a filtering process when the prediction mode of the current block is the DC mode.

The reconstructed block and/or picture may be provided to the filter unit 240. The filter unit 240 may include a deblocking filter unit, a sample adaptive offset unit, and/or an adaptive loop filter unit for processing the reconstructed block and/or picture. The deblocking filter unit may receive information indicating whether a deblocking filter is applied to the corresponding block or picture provided from the picture encoding apparatus, and information indicating whether a strong filter or a weak filter is applied when a deblocking filter is applied. The deblocking filter unit may receive a piece of information related to the deblocking filter provided by the picture encoding apparatus and may perform deblocking filtering on the corresponding block in the picture decoding apparatus.

The sample adaptive offset unit may perform an offset correction for the reconstructed picture based on a type of the offset correction and a piece of offset value information applied to the picture at the time of encoding. The adaptive loop filter unit may be applied as a coding unit based on information such as information indicating whether the adaptive loop filter provided from the encoder is applied or the coefficient information of the adaptive loop filter. The information associated with the adaptive loop filter may be provided in a specific parameter set.

The memory 245 may store the reconstructed picture or block, use the reconstructed picture or block as a reference picture or reference block in the subsequent processes, and also provide the reconstructed picture to the output unit.

Although omitted herein for the sake of convenience, the bit stream input to the decoding apparatus may be input to the entropy decoding unit through a parsing step. In addition, the entropy decoding unit may perform the parsing process.

In this specification, it may be interpreted that a coding step means an encoding process or a decoding process in some cases, and information includes both values, parameters, coefficients, elements, flags, and the like. “A screen” or “a picture” generally means a unit that represents one picture in a specific time zone, and “a slice”, “a frame”, or the like Is a unit that constitutes a part of a picture in the coding of an actual video signal. They may be used in combination with a picture, if necessary.

The terms, ‘pixel’, ‘pixel’ or ‘pel’ represents the smallest unit constituting a single picture. Further, as a term indicating the value of a specific pixel, ‘sample’ may be used. The sample may be divided into luminance (Luma) and chroma (chroma) components, but generally it may be used as a terminology including both of them. The chrominance component represents a difference between predetermined colors, and is generally composed of Cb and Cr.

A ‘unit’ refers to a specific unit of a basic unit or a picture, such as the encoding unit, the prediction unit, and the transform unit described above. In some cases, it may be used in combination with the terms such as ‘block’, ‘area’, or ‘part’. The block may also be used as a term indicating a set of samples or transform coefficients consisting of M columns and N rows.

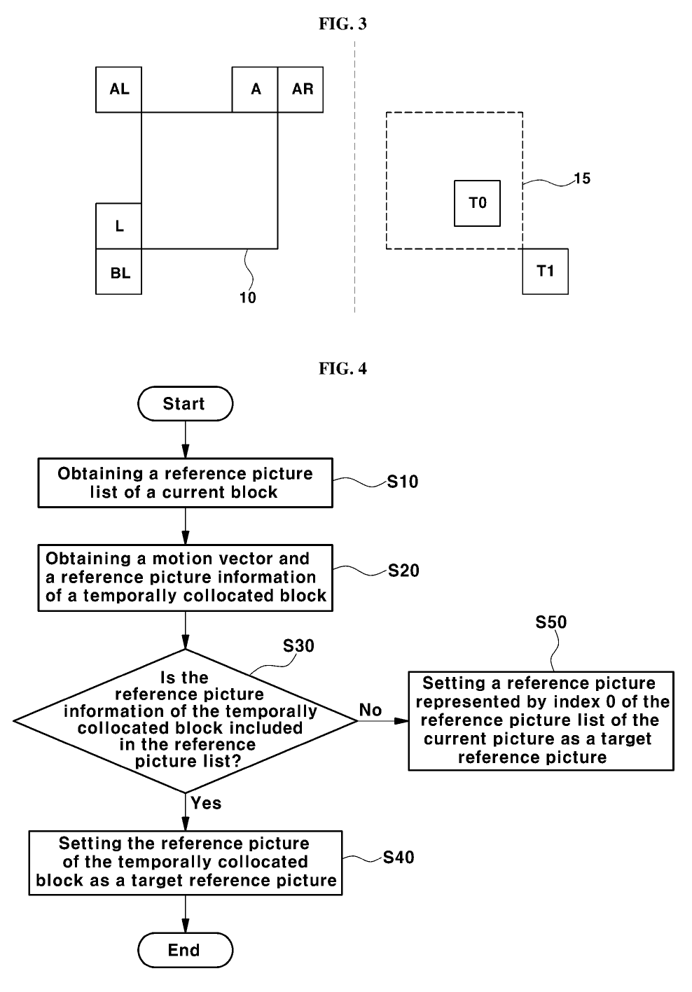

FIG. 3 is a block diagram illustrating temporal and spatial neighbor blocks of a current block according to a general method.

Referring to FIG. 3, a merge mode in which one of the motion information of collocated blocks located in the neighboring area of the current block 10 is used for coding the current block will be described. The collocated block includes the spatially collocated blocks A, AR, AL, BL, and L located at the left or upper side of the current block 10, and a spatially collocated block representing a corresponding block 15 having the same spatial coordinates as the current block 10 among the collocated pictures at a time different from the current block 10. The merge mode may code an index information for indicating whether the current block is coded using motion information of one collocated block among the temporally and spatially collocated blocks, and may transmit the coded index information.

First of all, in order to obtain a motion vector of a collocated block, a collocated block having an available motion vector may be searched to obtain a motion vector. The searching order for collocated blocks is set according to L->A->AR->BL->AL->T0->T1. In one embodiment, a motion vector of the spatially collocated block T0 or T1 may be used as the motion vector of the current block 10.

In this case, the reference picture list of the corresponding picture including the temporally collocated block 15 may be different from the reference picture list of the current picture including the current block 10. In the above case, prior to using the motion vector of the corresponding block as the motion vector of the current block, the motion vector of the corresponding block may be scaled based on the reference picture indicated by the index 0 of the reference picture list of the current picture to which the current block belongs. In summary, in the merge mode, the motion vector may be scaled by setting the 0 index picture of the reference picture list of the current block as the target reference picture.

FIG. 4 is a flowchart illustrating a method for decoding a video signal for setting a target reference picture according to an embodiment of the present invention.

First of all, according to the general method for setting the target reference picture described with reference to FIG. 3, when scaling a motion vector of a temporally collocated block, a reference picture list of a current picture different from a reference picture list of a corresponding picture including the temporally collocated block may be used in order to obtain a motion vector of a current block. In this case, since a scaling step may be performed using a reference picture having a low similarity for the temporally collocated block, the coding efficiency may be degraded. Therefore, a method for setting a target reference picture according to an embodiment of the present invention employs a new method to solve this problem.

Referring again to FIG. 4, in order to set a target reference picture for obtaining a motion vector of a current block, a reference picture list indicating at least more than one reference picture information of the current block may be obtained (S10). The reference picture list may be one or two, but the present invention is not limited thereto. In addition, the motion vector and the reference picture information of the temporally collocated block of the current block may be obtained (S20). The temporally collocated block may be same as that described with reference to FIG. 3, and the reference picture information of the temporally collocated block may be obtained together with the motion vector of the temporally collocated block.

Hereinafter, it is determined whether the reference picture information of the temporally collocated block is same as the reference picture included in the reference picture list of the current picture to which the current block belongs (S30). The method for determining whether the reference picture information of the temporally collocated block is included in the reference picture list of the current picture is not limited. According to the present invention, a method for setting a target reference picture may be variously set according to whether reference picture information of the temporally collocated block is included in the reference picture list of the current picture.

For example, if the reference picture information of the temporally collocated block is same as the reference picture information included in the reference picture list of the current picture, the reference picture of the temporally collocated block may be set as a target reference picture used for scaling the motion vector of the temporally collocated block (S40). Further, if the reference picture information of the temporally collocated block is different from the reference picture included in the reference picture list of the current picture, a reference picture represented by index 0 of the reference picture list of the current picture may be set as the target reference picture (S50). However, if the reference picture information of the temporally collocated block is different from the reference picture included in the reference picture list of the current picture, the method for setting the target reference picture is not limited to thereto, and a reference picture having the smallest difference between the reference picture information of the temporally collocated block among the reference picture included in the reference picture list of the current picture, and the POC value may be selected.

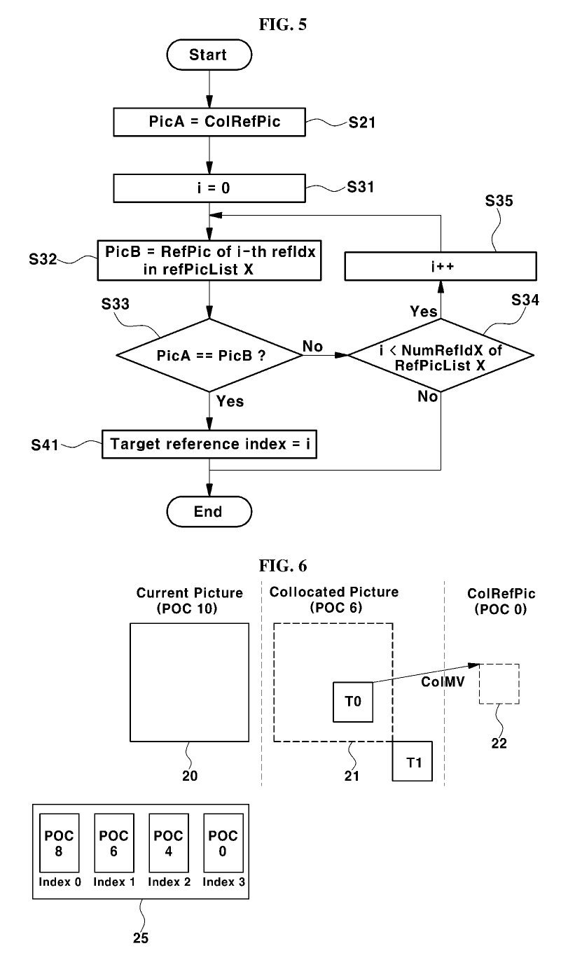

FIG. 5 is a flowchart illustrating a method for setting a target reference picture according to an embodiment of the present invention.

Referring to FIG. 5, a motion vector of a temporally collocated block considered to encode a current block and a reference picture information (ColRefPic) referring to the motion vector may be obtained. At this time, the reference picture information (ColRefPic) may be stored in the variable PicA (S21). The index i of the reference picture of the current picture including the current block is set to 0 (S31), and the number (RefPic of i-th refIdx in refPicList X) of the i-th reference picture included in the reference picture list of the current picture may be stored in the variable PicB (S32).

Hereinafter, it is determined whether the variable PicB indicating the number of the i-th reference picture of the current picture and the variable (ColRefPic) indicating the reference picture information of the temporally collocated block are same (PicA==PicB) (S33). If PicA==PicB, the reference picture represented by PicA may be set as the target reference picture (S41). If PicA and PicB are different from each other, it is checked whether the index i indicating the reference picture included in the reference picture list of the current picture is smaller than the number of reference pictures included in the reference picture list (S34), and if the index i is smaller than the number, the index i is incremented by 1 (S35). Then, the number (POC) of the i-th reference picture is stored in the variable PicB (S32), and it is determined whether the variables PicA and PicB are identical or not (S33).

If the index i is continuously incremented and the reference picture of the temporal collocated block is not same as all the reference pictures of the reference picture list of the current picture, the reference picture represented by index 0 of the reference picture list of the current picture including the current block may be set as a target reference picture. However, if the reference picture of the temporally collocated block is not same as all the reference pictures included in the reference picture list of the current picture, the method for setting the target reference picture is not limited thereto.

When the target reference picture is set as described, the motion vector of the temporally collocated block may be scaled using the relation between the reference picture of the temporally collocated block, and the target reference picture according to the above setting, and the scaled motion vector may be used for coding the current block. In connection with a coding process of the current block, if the current block is coded by a merge mode, merge skip mode, ATMVP, STMVP or the like, the scaled motion vector is used as the motion vector of the current block as it is, and the scaled motion vectors may be combined with other motion vectors so that the combined motion vectors may be used as a motion vector of the current block. The combination of the motion vectors may indicate that a new motion vector is generated by combining at least more than one motion vector or a new prediction block is generated by combining the prediction blocks indicated by the motion vectors, but the present invention is not limited thereto.

FIG. 6 is a diagram illustrates a method for setting a target reference picture according to an embodiment of the present invention.

Referring to FIG. 6, the picture number (POC) of a current picture including the current block 20 may be 10, and the picture number of a collocated picture including a temporally collocated block (corresponding block, 21) of the current block may be six. Further, ColMV, which is a motion vector at the T0 position in the corresponding block 21 may be used as a temporal motion vector TMVP of the current block, and the picture number (POC) of the picture ColRefPic including the block 22 referred to by the motion vector ColMV may be zero. In this case, the index 3 may be set as the target reference picture for coding the motion vector of the current block, because POC of the reference picture indicated by the index 3 in the reference picture list of the current picture is equal to 0 and it is same as the picture number of the ColRefPic.

That is, the picture same as the reference picture of the temporally collocated block may exist in the reference picture list 25 of the current picture including the current block. Therefore, it may be used as the motion vector for coding the current block by scaling the motion vector ColMV on the basis of the reference picture index 3 of the reference picture list of the current picture, which is same as the reference picture of the temporally collocated block. If the reference picture list does not include the picture same as the reference picture of the temporally collocated block, the target reference picture for scaling the motion vector ColMV may use a picture which is set according to the conventional method. For example, if the picture same as the reference picture of the temporally collocated block is not included in the reference picture list, a picture of POC=8 which is an index 0 of the reference picture list may be used as a target reference picture.

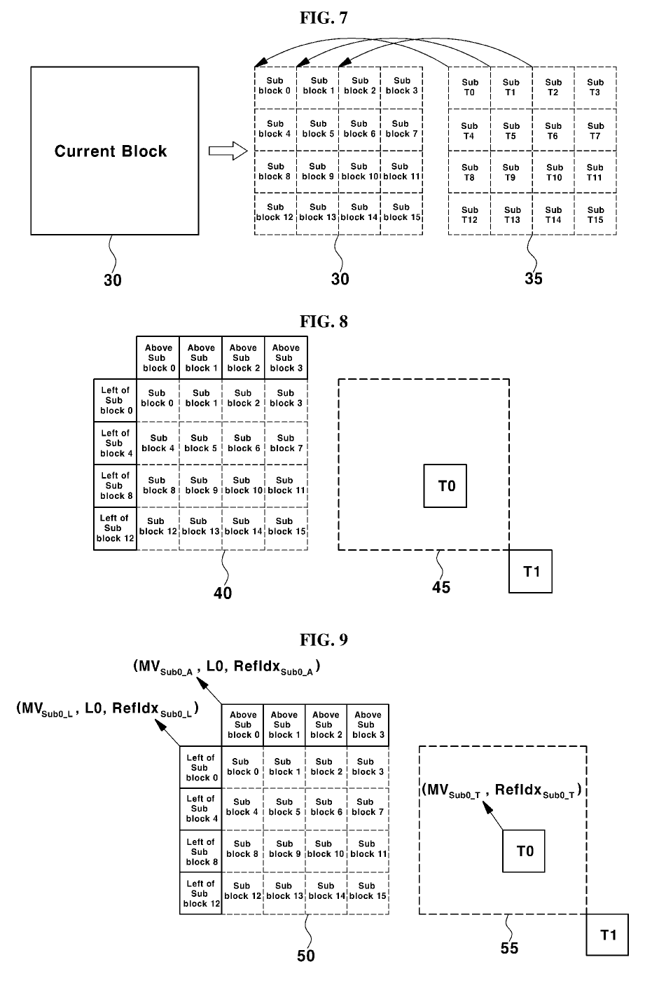

FIG. 7 and FIG. 8 illustrate a method for merging a current block using motion vectors of a corresponding block (FIG. 7, ATMVP) to encode the current block into one of merge modes, and a merge mode method (FIG. 8, STMVP) for coding a current block using motion vectors generated by combining the motion vectors of collocated blocks of the current block and the motion vector of a collocated block, respectively, which are methods used in JEM 3.0.

Referring to FIG. 7, first of all, it is checked whether there is a collocated block having a motion vector among the collocated blocks of the current block 30, and a block indicated by the motion vector among the pictures indicated by the motion vector of the collocated block which is first identified may be designated as an association block (corresponding block 35). After the association block 35 is determined, the current block 30 and the association block 35 are divided into the current sub-blocks (sub-block 0 . . . 15) of 4×4 units, and a motion vector of an association sub-block (sub T0 . . . T15) at the same position in the association block may be used as a motion vector of the current sub-block.

Hereinafter, the current sub-blocks may have different temporal motion vectors, respectively. For example, the current sub-block 0 uses the motion information of the sub-block T0 of the association block as a temporal motion vector, and the current sub-block 1 may use the motion vector of the sub-block T1 of the association bloc. In this case, since the reference picture list of the picture including the association block is different from the reference picture list of the current picture including the current block, the motion information of the association sub-block should be scaled based on the index picture corresponding to the number 0 in the reference picture list used by the picture including the current sub-block in order to use the motion vectors of the association sub-blocks. In other words, the motion vector of the association sub-block may be scaled by setting the index picture corresponding to the number 0 in the reference picture list of the current picture including the current block 30 as the target reference picture.

Referring FIG. 8, it depicts a process for calculating a motion vector used in STMVP which is a merge mode of JEM 3.0. A current sub-block divided by 4×4 may also have 4×4 collocated sub-blocks in the collocated region. In order to generate a motion vector of a current sub-block, first of all, a step for combining a motion vector of a left collocated block of the current sub-block, a motion vector of an upper collocated block of the current sub-block, and a motion vector obtained from a temporally collocated block is performed. Then, the combined motion vector may be used as a motion vector of the current sub-block.

The method for generating a motion vector from the temporally collocated block may be same as the general TMVP generating method described with reference to FIG. 3, but the present invention is not limited thereto. For example, when the current sub-block is a sub block 0, TMVP is obtained from the motion information of sub block 0 at the left side of the current sub-block, the motion information of the upper side of the sub-block 0, and the temporally collocated block. Then, these three motion vectors may be combined and used as a motion vector of the current sub-block 0. In this case, since the reference picture list of the picture including the temporally collocated block is different from the reference picture list of the current picture including the current block 40, a process for scaling the motion vector of the temporally collocated block 45 is required based on the index picture 0 of the reference picture list of the current picture in order to obtain the TMVP.

That is, the 0-th index picture of the reference picture list of the current picture may be set as the target reference picture so as to scale the motion vector of T0 position or T1 position located at the lower right side of the temporally collocated block 45. However, in this case, since the reference picture of the current picture having a low correlation for the scaling of the motion vector of the temporally collocated block may be used, the coding efficiency may be deteriorated. In order to solve this problem, the present invention proposes the following method.

FIG. 9 is a diagram illustrating a method for obtaining a motion vector using a target reference picture according to another embodiment of the present invention.

Referring to FIG. 9, the current block 50 is divided into current sub-blocks, which correspond to at least more than two sub-blocks (sub-block 0 . . . 15), and spatially collocated blocks (corresponding number does not exist) of the current sub-block may be obtained. For example, the sub-block 0 can obtain the motion information (MVSub0_L, L0, RefIdxSub0_L) of the left block and the motion information (MVSub0_A, L0, RefIdxSub0_A) of the upper block may be obtained. Further, motion information (MVSub0_T, RefIdxSub0_T) of T0 position or T1 position located at the lower right side of the temporally collocated block 55 may be obtained, and this motion information may be scaled based on the target reference picture before being combined with the motion vectors of the spatially collocated blocks.

The target reference picture may be set according to the method described with reference to FIG. 4-FIG. 6. That is, when the reference picture of the picture to which the temporally collocated block belongs is included in the reference picture list of the current picture including the current sub-block, the reference picture of the picture to which the temporally collocated block belongs may be set as the target reference picture. If the reference picture of the picture to which the temporally collocated block belongs is not included in the reference picture list of the current picture, the 0th index picture of the reference picture list of the current picture may be set as the target reference picture.

Hereinafter, a motion vector of the current sub-block may be generated by combining two motion vectors of the spatially collocated block and a motion vector of the scaled temporally collocated block. In this case, the position and the number of the collocated blocks referred to by the current sub-block are not limited to the present invention, and the method for combining available motion information of the collocated sub-blocks is not limited to the present invention.

As described above, when a motion block of a current block is generated using motion information of a temporally collocated block of the current block, if a reference picture of the picture including the temporally collocated block exists in the reference picture list of the current block, the coding efficiency may be improved by using it as a target reference picture.

Hereinafter, a method for setting a residual merge candidate value in a merge candidate index to which no motion information is allocated in the merge mode will be explained in detail.

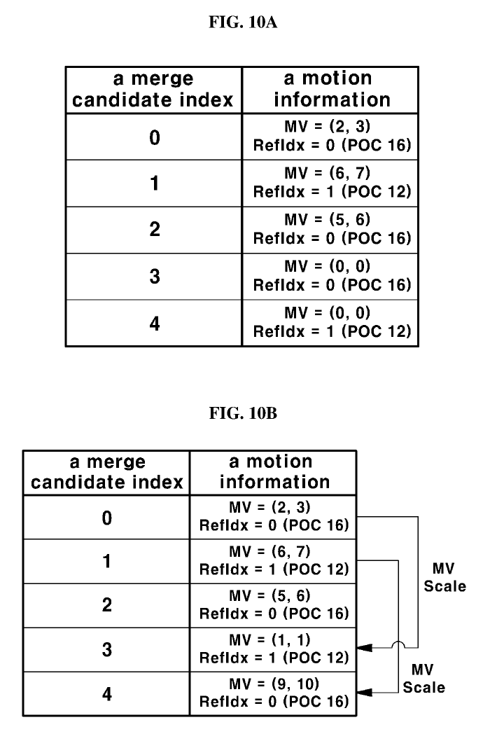

FIG. 10A and FIG. 10B are the diagrams illustrating a method for obtaining a residual merge candidate according to another embodiment of the present invention.

Referring to FIG. 10A, the number of acquired merge candidates may be smaller as compared with the maximum number of merge candidates (MaxNumMergeCandidates) available in the merge mode. In this case, (0, 0) may be assigned as the reference picture and the motion vector corresponding to the index of the smallest number with respect to the index of the residual merge candidate that is the merge candidate to which the motion information is not allocated. For example, if the number of residual merge candidates is two in FIG. 10A, that is, if the motion information corresponding to the index 3 and the index 4 is not available, POC=16 and MV=(0, 0), which are reference pictures of the index 0, may be allocated to the merge candidate index 3 which is the first unallocated residual merge candidate among the residual merge candidates. In addition, POC=12 and MV=(0, 0), which are reference pictures of the index 1, may be allocated to the merge candidate index 4 which is the second unallocated merge candidate among the residual merge candidates.

However, the method for determining the index of the target reference picture proposed in the present invention is described below with reference to FIG. 10B. As illustrated in FIG. 10B, when there is a residual merge candidate (the candidates corresponding to the index 3 and the index 4) with respect to the merge candidate of the current block, the motion information of the merge candidate already allocated is scaled with respect to the target reference picture and then, the scaled motion information may be used as a motion information of a residual merge candidate. For example, if there are three available residual merge candidates which are already allocated in the merge mode using five merge candidates, the merge candidate corresponding to the merge candidate index 4 among the residual merge candidate scales the first available merge candidate (index 0), and the merge candidate corresponding to the merge candidate index 5 can be used by scaling the second available merge candidate (index 1).

The target reference picture used for the scaling is different from the reference picture index of the merge candidate to be scaled, and may be a reference picture represented by the smallest reference picture index of the reference picture list of the current picture. For example, when the fourth merge candidate (merge candidate index 3) is constructed, the motion information of the merge candidate index 0 is scaled and used. At this time, the target picture for scaling is different from the picture indicated by the merge candidate index 0, and the reference picture having the smallest index value among the reference picture list may be set as the target picture. Since the merge candidate index 0 is RefIdx=0 (POC 16) in FIG. 10B, the merge candidate index 3 may set the picture of RefIdx=1 as the target reference picture, which means that POC 12 may be set as the target reference picture of the merge candidate index 3.

Further, the fifth merge candidate (merge index 4) is constructed by scaling the motion vector of the merge candidate index 1. At this time, the target reference picture may be set to RefIdx=0, which is the smallest list value in the reference picture list of the current picture, and is different from the reference picture (RefIdx=1, POC 12) indicated by the merge candidate index 1. This means that POC=16 is set as the target reference picture of the merge candidate index 4. However, the method for setting the target reference picture in the present invention is not limited thereto.

The method for setting a target reference picture according to an embodiment of the present invention may be used not only for obtaining temporal motion information, but also for obtaining spatial motion information. Further, the method for scaling a motion vector for generating a residual merge candidate using the available merge candidate of the present invention, the method for determining the index of the target reference picture, or the method for selecting the available merge candidate is not limited.

As described above, according to a method for obtaining a residual merge candidate of the present invention, a method for decoding a video signal for improving coding efficiency in inter prediction by obtaining a residual merge candidate using a previously obtained merge candidate, and an apparatus for realizing the method are provided.

Further, in a general method, when TMVP using motion information of a temporally collocated block in a merge mode is used as a merge candidate, and the type of the reference picture of the temporally collocated block and the type of the target reference picture of the current picture including the current block are different from each other, the TMVP may not be used as a merge candidate. The present invention proposes a method for solving this problem.

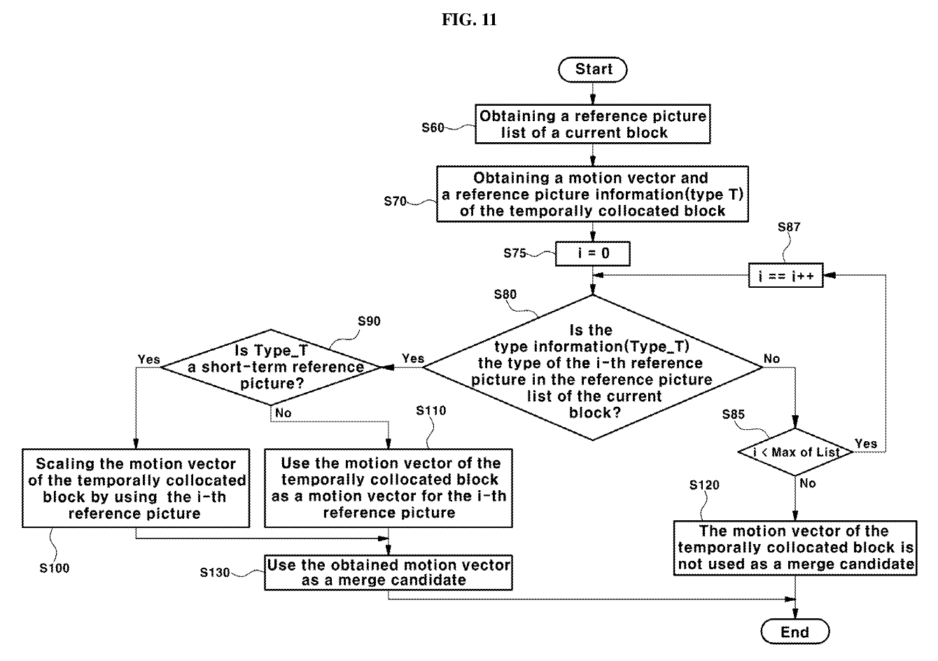

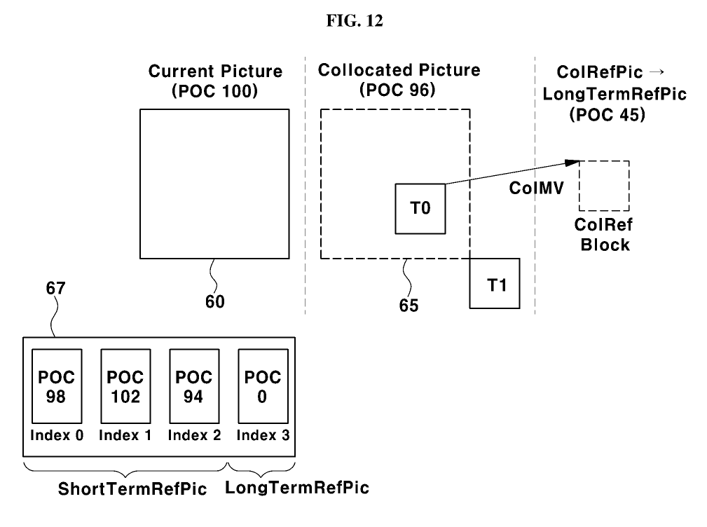

FIG. 11 is a flowchart illustrating a method for setting a target reference picture according to another embodiment of the present invention. FIG. 12 is a diagram illustrating a method for setting a target reference picture according to another embodiment of the present invention.

Referring to FIGS. 11 and 12, a reference picture list of the current block 60 may be obtained (S60). The reference picture list may include type information of each of the reference pictures included in the list, and the type information may be of a long-term type and a short-term type. In addition, the motion vector and the reference picture information at T0 position or T1 position located at the lower right side of the temporally collocated block 65 of the current block 60 may be obtained (S70). The reference picture information of the temporally collocated block may include type information (Type_T) of the reference picture.

In order to compare the type information (Type_T) of the reference picture of the temporally collocated block with the types of reference pictures of the reference picture list of the current block, the reference picture index i indicating the reference picture in the reference picture list is initialized to 0 (S75). Then, the type information (Type_T) of the reference picture of the temporally collocated block is compared with the type of the i-th reference picture in the reference picture list of the current block (S80). If the type T is different from the type of the i-th reference picture (No in S80), it may be determined whether the i-th reference picture is the last reference picture in the reference picture list or not (S85). If the i-th reference picture is not the last reference picture, the i-th value is increased (S87), and the type information of the next reference picture in the reference picture list and the type information of the reference picture of the temporally collocated block are same or not (S80).

If the type T is same as the type of the i-th reference picture (Yes in S80), first of all, it is determined whether the type information corresponding to the type T is the short-term reference type (S90). In this case, if the type T is a short-term reference type (Yes in S90), the motion vector of the temporally collocated block is scaled with respect to the i-th reference picture (reference picture of the same type as the type T) (S100) and then is used as a motion vector of a merge mode for encoding the current block (S130). Otherwise, if the corresponding type information (Type_T) is a long-term reference type (No in S90), the motion vector of the temporally collocated block is regarded as a motion vector for the i-th reference picture without performing any scaling process, and this is used as a candidate of a motion vector for encoding the current block into merge mode (S110).

In this way, the obtained motion vectors may be used as merge candidates (S130). If no pictures in the reference picture list of the current picture is of the same type as the reference picture of the temporally collocated block, the motion vector of the temporally collocated block is not used in the merge mode process for the current block (S120).

If the motion vector of the temporally collocated block is not used in the merge mode (S120), a predetermined value may be used as a candidate motion vector for performing merge mode. For example, (0,0) may be used. In this case, the target reference picture may be set as a reference picture indicated by index 0 in the reference picture list of the current picture.

Referring to FIG. 12, the reference picture referred to by the motion vector (ColMV) of the temporally collocated block 65 may be a long-term reference picture type. In this case, according to the conventional method, if the zero index picture of the reference picture list of the current picture is a short-term reference picture type, the motion vector may not be used as a motion vector for encoding the current block into a merge mode. However, according to an embodiment of the present invention, when the type of the reference picture referenced by the motion vector and, the type of the zero index picture in the reference picture list of the current picture are different from each other, a reference picture having the same type as the reference picture referenced by the motion vector in the reference picture list may be set as the target reference picture for scaling the motion vector.

For example, if the motion vector ColMV at the T0 position or T1 position of the lower right side in the corresponding block 65 refers to the picture of POC=45 which is the reference picture of the long-term type, and there is a long-term reference picture in the reference picture list of the current block 60, the index of the target reference picture used for generating the motion vector of the current block using the motion vector may be changed from 0 (POC=98) to 3 (POC=0). If at least more than two reference pictures of the same type as the reference picture type of the motion vector exist in the reference picture list 67, a reference picture having the smallest index value may be set as the target reference picture.

In one embodiment, when the type of the reference picture of the motion vector is a long-term type and a reference picture of a long-term type exists in the reference picture list 67, the motion vector may be used as it is without being scaled. At this time, only the reference picture may be changed to a corresponding reference picture in the reference picture list. If there are a plurality of long-type reference pictures in the reference picture list, the reference picture to which the smallest index number is allocated may be set as the target picture.

In one embodiment, when the type of the reference picture of the motion vector is a short-term type, and a plurality of reference pictures of a short-term type are present in the reference picture list 67, a reference picture to which the smallest index number is allocated may be set as a target picture. At this time, the motion vector may be scaled and used for the selected target picture. Further, if the type of the reference picture of the motion vector does not match the types of all the reference pictures in the reference picture list 67, the motion vector is not used in the process of encoding the current block into the merge mode. In this case, a predetermined value may be used as a candidate motion vector for performing the merge mode. For example, (0, 0) may be used. At this time, it may be set as a reference picture indicated by the smallest index.

However, the method for setting the target reference picture is not limited to thereto, and a reference picture of the same type as the reference picture type of the motion vector may be set as the target reference picture.

In this way, the method for setting a target reference picture according to an embodiment of the present invention uses a reference picture in a reference picture list of a current block having the same picture type as a reference picture of a temporally collocated block as a target reference picture, thereby effectively coding the current block.

It will be apparent to those skilled in the art to which the present invention pertains that the present invention described above is not limited to the above-described embodiments and the accompanying drawings, and various replacements, modifications and variations may be made in the present invention without departing from the technological concepts of the invention.

1. A method for decoding a video signal comprising:
a step for obtaining a reference picture list indicating at least more than one reference picture information of a current block;
a step for obtaining a motion vector of a temporally collocated block of the current block and a reference picture information of the temporally collocated block;
a step for confirming whether or not the reference picture information of the temporally collocated block is included in the reference picture list of the current block; and
a step for setting a target reference picture for scaling a motion vector of the temporally collocated block according to whether the reference picture information of the temporally collocated block is included or not.

2. The method for decoding a video signal of the claim 1, wherein the step for setting the target reference picture set the reference picture information as the target reference picture if the reference picture information of the temporally collocated block is included in the reference picture list.

3. The method for decoding a video signal of the claim 1, wherein the step for setting the target reference picture may set a reference picture having the smallest index among the reference picture list as the target reference picture if the reference picture information of the temporally collocated block is not included in the reference picture list.

4. The method for decoding a video signal of the claim 1, further comprising,
a step for dividing a current block into at least two or more sub-blocks;
a step for obtaining a motion vector of a spatially collocated block of the sub-block;
a step for scaling a motion vector of the temporally collocated block using the target reference picture; and
a step for generating a motion vector of the sub-block using the motion vector of the spatially collocated block and the motion vector of the scaled temporally collocated block.

5. The method for decoding a video signal of the claim 4, wherein the step for setting the target reference picture may set the reference picture information as the target reference picture if the reference picture information of the temporally collocated block is included in the reference picture list.

6. The method for decoding a video signal of the claim 4, wherein the step for setting the target reference picture may set the reference picture information having a smaller index among the reference picture information of the spatially collocated block included in the reference picture list, as the target reference picture, if the reference picture information of the temporally collocated block is not included in the reference picture list.

7. A method for decoding a video signal including a method for obtaining a merge candidate of a merge mode comprising,
a step for obtaining a maximum number information of merge indicating a maximum number of merge candidates in the merge mode;
a step for obtaining a merge candidate of the current block using at least more than one motion vector selected from a motion vector of a temporally collocated block of a current block and a motion vector of a spatially collocated block;
a step for comparing the number of obtained merge candidate with the maximum number information of merge; and
a step for obtaining a residual merge candidate by scaling the obtained merge candidate if the number of obtained merge candidate is smaller than the maximum number information of merge.

8. The method for decoding a video signal of the claim 7, wherein the step for obtaining the residual merge candidate scales the obtained merge candidate using the target reference picture, and the target reference picture is different from the reference picture of the obtained merge candidate, and becomes a reference picture having the smallest index among the reference picture list.

9. A method for decoding a video signal comprising;
a step for obtaining a reference picture list indicating at least more than one reference picture information of a current block;
a step for obtaining a motion vector of a temporally collocated block of the current block and a reference picture information of the temporally collocated block;
a step for confirming whether a type of a reference picture of the temporally collocated block of the current block, and a type of a reference picture having a small index of the reference picture list are identical or not;
a step for setting a reference picture of the same type as the temporally collocated reference picture as a target reference picture if the types of the reference pictures are same; and
a step for determining whether or not the type of the reference picture in the reference picture list, and
the type of the reference picture of the temporally collocated block are same by incrementing the index of the reference picture list by one if the types of the reference picture are different from each other.

10. The method for decoding a video signal of the claim 9, wherein the reference picture of the same type is a reference picture having the smallest index among the reference pictures of the same type as the temporally collocated reference picture.

11. The method for decoding a video signal of the claim 9, further comprising,
a step for determining whether the type of the reference picture of the temporally collocated block is a short-term reference picture or not, if the type of the reference picture of the temporally collocated block is same as the type of the reference picture having the small index of the reference picture list;
a step for setting a reference picture of the same type in the reference picture list as the target reference picture for a motion vector of the temporally collocated block if the type of the reference picture of the temporally collocated block is a short-term reference picture;
a step for scaling a motion vector of the temporally collocated block using the same type of reference picture of the same type, and using the scaled motion vector as a merge candidate; and
a step for using the motion vector of the temporally collocated block as a merge candidate of the current block without scaling the motion vector of the temporally collocated block if the type of the reference picture of the temporally collocated block is a long-term reference picture.

12. The method for decoding a video signal of the claim 9, further including a step for allocating a predetermined value as a motion vector of the current block when it is judged that the type of the reference picture is different from the type of all the reference pictures in the reference picture list as a result of determining whether the type of the reference picture is same or not.

13. An apparatus for decoding a video signal comprising,
a picture information obtaining unit for obtaining a reference picture list indicating at least more than one reference picture information of a current block, a motion vector of a temporally collocated block of the current block, and a reference picture information of the temporally collocated block;
a reference picture information discrimination unit for confirming whether a reference picture information of the temporally collocated block is included in the reference picture list of the current block; and
a target reference picture setting unit configured to set a target reference picture for scaling a motion vector of the temporally collocated block according to whether the reference picture information of the temporally collocated block is included or not.

14. The apparatus for decoding a video signal of the claim 13, wherein the target reference picture setting unit sets a reference picture indicated by the reference picture information as the target reference picture when the reference picture information of the temporally collocated block is included in the reference picture list.

15. The apparatus for decoding a video signal of the claim 13, further including a block dividing unit for dividing the current block into at least two or more sub-blocks;
a motion vector obtaining unit for obtaining a motion vector of a spatially collocated block of the sub-block and scales the motion vector of the temporally collocated block using the target reference picture; and
a motion vector generation unit for generating a motion vector of the sub-block using the motion vector of the spatially collocated block and the motion vector of the temporally collocated block.

16. An apparatus for obtaining a merge candidate of a merge mode comprising,
a maximum merge number information obtaining unit for obtaining a maximum number information of a merge indicating a maximum number of merge candidates of the merge mode, and for obtaining a merge candidate of the current block by using at least more than one motion vector selected from a motion vector of a temporally collocated block of a current block and a motion vector of a spatially collocated block of a current block; and
a residual merge candidate obtaining unit for comparing the number of the obtained merge candidates with the number of the maximum number information of a merge, and for scaling the obtained merge candidate to obtain the residual merge candidate if the number of the obtained merge candidates is smaller than the number of the maximum number information of a merge.

17. An apparatus for decoding a video signal comprising,
an information obtaining unit for obtaining a reference picture list indicating at least more than one reference picture information of a current block, a motion vector of a temporally collocated block of the current block, and reference picture information of the temporally collocated block;
a type confirmation unit for confirming whether or not a type of a reference picture of a temporally collocated block of the current block is same as a type of a reference picture having a small index of the reference picture list; and
the target reference picture setting unit for setting the reference picture of the same type as the temporally collocated reference picture type as the target reference picture, if the types of the reference pictures are same, and wherein if the types of the reference pictures are different from each other, it is determined whether the reference picture in the reference picture list and the reference picture of the temporally collocated block are the same type by incrementing an index of the reference picture list by one.
